(19) United States
(12) Patent Application Publication
(10) Pub. No.: US 2004/0093240 A1
(43) Pub. Date: May 13, 2004

(54) Systems and methods for clinical trials information management

(76) Inventor: Rajesh Navanital Shah, Herndon, VA (US)

Correspondence Address: MICHAEL D. BEDNAREK, SHAW PITTMAN LLP, 1650 TYSONS BOULEVARD, MCLEAN, VA, 22102, US

(21) Appl. No.: 10/690,553

(22) Filed: Oct. 23, 2003

Related U.S. Application Data
(60) Provisional application No. 60/420,253, filed on Oct. 23, 2002.

(51) Int. Cl. G06F 17/60

(52) U.S. Cl. 705/2

(57) ABSTRACT

Embodiments of the present invention relate to systems and methods for managing clinical trials. A system for managing clinical trials includes a Web client, a client, a server, and a patient records database. The server provides a number of different applications a user can run, depending on their role in the clinical trials process. These applications are divided into core and non-core components. In an exemplary embodiment, there are twenty nine core and non-core components. Information from the patient records database is reported based on the role in the clinical trials process of the user accessing the information. Users with different roles are called stakeholders. Stakeholders include sponsor, regulator, investigator, site, patient, and monitor. Methods for reporting clinical trials information, monitoring clinical trial events, scheduling and tracking appointments, providing good clinical information, closing-out a trial, and displaying information to stakeholders are disclosed.

### CROSS-REFERENCE TO RELATED APPLICATION

This application claims the benefit of U.S. Provisional Patent Application Serial No. 60/420,253 filed Oct. 23, 2002, which is herein incorporated by reference in its entirety.

### BACKGROUND OF THE INVENTION

1. Field of the Invention

Embodiments of the present invention relate to systems and methods for managing information. More particularly, the present invention relates to systems and methods for managing clinical trials information and facilitating communication among all of the key stakeholders conducting a clinical trial.

2. Background Information

In today's technological world, inter-communication between parties from all over the globe has made it necessary to devise ways to control such large amounts of information. Although more efficient methods of communicating, such as cellular telephones and the Internet, enable increased levels of information to be transferred between parties, such information flow at higher volumes has proven to be near chaotic, and thus, important information may be lost in high traffic volume. One such industry where there is a high level of information being generated, and a corresponding high level of information being lost in the traffic, is the clinical trials industry. Few industries are as information-laden as the clinical trials industry or as inefficient in management of information.

The clinical trials industry is comprised of a vast network of interdependent and diverse participants with interest in the industry. Such participants may also be labeled “stakeholders” in the clinical trials industry because each such participant has an interest in this network. For example, some interest in the network arise from being involved with producing, monitoring, collecting, analyzing, reporting, and mining clinical information. All such interest and participation in the industry culminate in the goal of producing medical advances to benefit society and individuals.

The processes involved in advancing medical solutions must meet rigorous industry standards, federal and international regulations, as well as unique requirements specific to each participant. For example, one of the most significant challenges that stakeholders encounter in a modern clinical trials environment is to minimize the inefficiencies in management of clinical information. Important information, such as data, in the drug development process is typically collected using a paper-based system in which each critical data element is transcribed or re-entered numerous times, for example, an average of three to ten times. The data element is then verified a suitable number of times in order to give a level of confidence of fidelity. Not all data elements are individually verified in a typical methodology, rather, a representative sampling is monitored for accuracy by personnel trained in monitoring and auditing.

Another problem that arises in known processes for clinical trials is poor communication between elements in the process. FIG. 1 is an illustration of a known process for conducting clinical trials, and shows a number of weaknesses in the communication between elements as leaky pipes. For example, in process 100 scientific management element 101 communicates with regulatory management element 102 via leaky pipe 103. Leaky pipe 103 may be a paper-based form that scientific management fills out at the request of regulatory management. The problem is that this information is not visible to other parts of the system such as grants management element 104. Also, notice that grants management element 104 and regulatory management element 102 have their own databases 114 and 112, respectively. In other words, this important information may only be known to scientific and regulatory management, and is therefore, leaked from the process as a whole.

Collected data from across the stages of drug development and phases of clinical investigation is typically interwoven, analyzed and extracted into numerous reports, regulatory documents, publications and prescriber information sheets, such as package inserts. Such data must accurately disclose the level of compliance with federal and international regulations, industry standards and oversight body guidelines. Data should be of the highest quality, maintain its fidelity, be handled in a proprietary and confidential manner, and clearly demonstrate safety, efficacy and scientific/medical relevance. In the modern clinical trials industry, such requirements are typically met, but at significant cost, usually in terms of effort, expenditure, and time. This cost translates to, for example, high healthcare costs, high data costs, high drug costs, and prolonged drug development times that are typical of the industry.

Further, significant redundancy exists within each of the numerous domains of the clinical trials industry resulting in each domain additionally functioning in a fragmented manner. Thus, tremendous inefficiencies and redundancies persist through the drug development process. Numerous factors have conspired to keep this industry delayed in its utilization of clinical information systems and therefore must be addressed when proposing a viable solution. There is a need for a comprehensive, robust, and configurable information management system. Further, an enterprise solution should be proposed that is readily adoptable by regulatory and clinical environments. Any such solution that addresses the inefficiencies of the industry should include a comprehensive IT solution that is capable of adapting to and advancing the goals of burgeoning medical and scientific knowledge, accelerating biotechnological advances, and promoting the FDA initiative to shorten approval timelines.

In view of the foregoing, it can be appreciated that a substantial need exists for systems and methods that can advantageously reduce the tremendous inefficiencies and redundancies that exist in known processes for conducting clinical trials.

### BRIEF SUMMARY OF THE INVENTION

Embodiments of the present invention relate to systems and methods for managing clinical trials. One embodiment of the present invention includes a Web client, a client, a server, and a patient records database. The Web client accesses the server via a Web connection and the client accesses the server via a network connection other than a Web Connection. The patient records database can be accessed by the server. It is logically partitioned and distributed based on a role in the clinical trials process of user. These roles include sponsor, regulator, investigator, site, patient, and monitor.

The server provides a number of different applications a user can run, depending on their role in the clinical trials process. These applications are divided into core and non-core components. Core components are those components required for minimal functionality of the system. Non-core components are additional applications that enhance the functionality of the system, but are not required.

Both core and non-core components are divided into eleven different types of applications based on their function in the clinical trials process. These types of applications are trial design, trial conduct, trial monitoring, trial analysis, trail closure, portal, commercial off-the-shelf software, good clinical information, applications interface, security, and trial submission.

Trial design applications allow the design, development, and customization of a clinical trial. There are three trial design applications. One of these applications is a core component and the remaining two are non-core components. The core component is the dictionary and standards component. It enables interfaces between the system and relevant dictionaries and standards. These dictionaries and standards include but are not limited to common data elements, common toxicity criteria, MedDRA codes, ICD9 codes, IMT codes, and Common Data Interchange Standards Consortium. The first non-core component is the clinical development planner component. The clinical development planner component assists in the identification of clinical trial candidates for development. It also helps in creating target product profiles. The second non-core component is the protocol manager component. The protocol manager component allows the definition of all elements of the clinical trial in a collaborative manner with tight document control.

Trial conduct applications manage the ongoing operations of the clinical trial. There are ten trial conduct applications. Nine are core components and one is a non-core component. The first core component is the change management system component. This component allows for the implementation of clinical quality assurance and control through the ability to revise, version, and track modifications and approvals on controlled documents and trial processes.. These controlled documents include protocols, informed consents, case reports forms, investigative brochures, patient materials, and advertising and marketing materials. The controlled processes include study schedule, drug handling procedures, monitoring procedures, etc.

The second core component is the subject registration manager component. One skilled in the art will recognize that a subject is typically a patient. This component registers patients and profiles them against clinical trial inclusion and exclusion criteria for appropriate patient recruitment. It also allows for the collection of demographic, payer, referring physician, and emergency information as one portion of the complete clinical trial-related electronic medical record. Finally, it captures information about the referring physician. It does this for the purposes of evaluating investigative site performance, ensuring protocol compliance with regard to enrollment, gathering patient population characteristics, and maintaining a two-way flow of information pertaining to the patients medical condition and progress through the trial.

The third core component is the financial account manager component. This component enables study budgeting and invoicing as well as gate-keeping of medical billing information. In this way, it assures that appropriate billing practices are maintained throughout the clinical trial process.

The fourth core component is the investigation agent manager component. This component allows the capture of all drug distribution, tracking, disposition, accountability, transfer, and return in accordance with regulations and the clinical trial protocol.

The fifth core component is the patient evaluation manager component. This component facilitates interpretive summaries, diagnosis code assignment, and treatment code assignment. This facilitation provides assurance of compliance with the clinical trial protocol, proper study visit documentation, streamlined serious adverse event reporting, and clinical outcome evaluation.

The sixth core component is the treatment regimen manager component. This component allows for a standardized mechanism for treatment courses and dose escalations. These courses and escalations are in accordance with algorithms that are configured according to the clinical trial protocol.

The seventh core component is the clinical data import manager component. This component allows the system to interface with radiology imaging systems for the import of radiographic data and diagnostic interpretations, medical information systems for the import of medical data, and laboratory information systems for the import of laboratory data for the clinical trial.

The eighth core component is the auto encoding component. This component codes disease categories and toxicity data through access to current global libraries and coding algorithms.

The ninth core component is the adverse event manager component. This component collects and tracks all adverse events in the clinical trial process including critical path tracking and reporting for those adverse events meeting the requirements for expedited reporting.

The non-core component of the trail conduct applications is the encounter scheduler and tracker component. This component integrates the scheduling of clinical trial-related visits with routine physician office visits. It also captures physician-patient encounter data from each clinical trial-related visit. This component maintains a record of patient status and off-study reason.

Trial monitoring applications provide information about the ongoing operations of the clinical trial at a moment of time during the clinical trial. There are four trial monitoring applications. Two are core components and two are non-core components. The first core component is the database snapshot generator component. This component enables access to data for real-time clinical trial status monitoring at definable intervals for oversight reporting, resource allocation, trend analysis, decision support, and interim analysis. The second core component is the subject status manager component. This component ascertains the status of all subjects in the clinical trial and captures the reasons for which subjects leave the clinical trial.

The first non-core component of the trial monitoring applications is the monitor and auditor manager component. This promotes compliance with regulations requiring specific monitoring and auditing of the clinical trial process. The second non-core component is the case report form manager component. This component allows the design and tracking of paper and electronic case report forms.

Trial analysis applications provide information about the results of the clinical trial up to the time the trial analysis application is accessed. There are two trial analysis applications. One is a core component and one is a non-core component. The core component is the clinical outcome manager component. This component generates interim and final clinical trial status reports. The non-core component is the executive information manager component. This component allows for the monitoring of key executive vital signs, data analysis, and business intelligence.

There is one trial closure application component. It is a core component. This component performs at least one function to close-out the clinical trial.

There is one portal application component. It is a core component. This component provides a user interface accessible through a Web connection.

There is one commercial off-the-shelf software application component. It is a core component. This component integrates external software used by the system.

There is one good clinical information application component. It is a core component. This component assures that collected data is compliant with industry regulations and standards, is in accordance with an organizational workflow and the clinical trial critical path, adheres to data integrity standards, and is maintained in accordance with security and privacy standards.

Applications interface applications allow clients, who are connected to the system via a connection other than a Web connection, to access the system. There are four applications interface applications. Two are core components and two are non-core components. The first core component is the application programming interface component. This component enables external applications to communicate with the system. The second core component is the XML Data Pump component. This component allows import and export of data in XML format to and from the patient records database.

The first non-core component of the applications interface application is the mobile connectivity component. This component allows mobile devices to enter and retrieve data as the client. The second non-core component is the patient records manager component. This component allows external electronic medical records to be added to the clinical trial process, which provides the system with demographic information.

There is one security application component. It is a core component. This component allows for network security and user-defined password-protected access to the data. It also allows for the addition of further security, data integrity and privacy provisions adapters in accordance with client needs, industry standards and regulations. These standards and regulations include, for example, Health Level 7, 21 CFR Part 11, Health Insurance Portability and Accountability Act (1996), and American Society for Testing and Materials requirements.

There is one trial submission application component. This is not a core component. This component assembles information required for regulatory submissions and generates reports for regulatory reporting.

A second embodiment of the present invention is a method for reporting clinical trials information within a system for managing clinical trials. The first step is to create reporting requirements for a stakeholder. A stakeholder is the sponsor, a regulator, an investigator, the site, a patient, or a monitor. One skilled in the art will appreciate that a stakeholder is equivalent to a role in the clinical trials process of a user. The second step is to extract data from the system based on the reporting requirements. The third step is to validate the data against regulations and standards. The fourth step is to create information from the data based on what is known about the stakeholder. Finally, the fifth step is to display the information created to the stakeholder.

A third embodiment of the present invention is a method for monitoring events within a system for managing clinical trials. The first step is performing an event in the clinical trials protocol. The second step is checking that event against business logic rules, federal regulations, and industry standards. The final step is alerting at least one stakeholder of the event.

A fourth embodiment of the present invention is a method for scheduling and tracking the appointments of a clinical trial subject. The first step is the design of a schedule of subject visits based on the clinical trial protocol. The second step is the enrollment of a subject based on the inclusion and exclusion criteria of the clinical trial protocol. The third step is the automatic scheduling of subsequent visits for the enrolled subject. Subsequent visits include but are not limited to office visits, laboratory tests, x-ray tests, procedures, and preparation for procedures. The fourth step is the generation of alerts that the enrolled subject should be sent reminders in advance of the subsequent visits. The fifth step is the generation of a checklist upon a visit by an enrolled subject. A checklist includes, but is not limited to items such as prompted the principal investigator review and signature, generated patient instructions, generated a coordinator checklist, checked laboratory results, checked pathology results, checked microbiology results, and checked study reports. The sixth step is documenting the checklist of items completed and not completed after the visit by the enrolled subject. The seventh step is documenting the cancelled and missed visits by an enrolled subject. The eighth step is the dropping of the enrolled subject from the clinical trial if the number of visits cancelled or missed exceeds a threshold. This threshold is, for example, 3 missed or cancelled visits. The ninth step is the notification of dropped subjects. This notification is, for example, a certified letter. The final step is documenting the withdrawal of an enrolled subject.

A fifth embodiment of the present invention is a method for assuring good clinical information in scheduling and tracking the appointments of a clinical trial subject within a system for managing clinical trials. The first step is to check a designed schedule of subject visits for consistency with a clinical trial protocol and the rules of informed consent. The second step is to collect subject information in a manner compliant with industry regulations and standards. The third step is to check the collected subject information against inclusion and exclusion criteria business logic rules. The fourth step is to change the coding of subject information to indicate enrolled and non-enrolled subjects. The fifth step is to check the lead time of a scheduled visit against all other scheduled visits for conflicts. The sixth step is to assure that reminder calls are made and documented in the system. The seventh step is to assure that due diligence is shown and documented in regard to cancelled and missed visits by subjects. The eighth step is to assure that proper methods are used to drop a subject from the clinical trial. The ninth step is to assure that proper notice is given to a dropped subject. The final step is to assure that the subject information of a dropped subject is properly identified in the system.

A sixth embodiment of the present invention is a method for alerting and reporting in scheduling and tracking the appointments of a clinical trial subject within a system for managing clinical trials. The first step is to generate subject instructions at the time of scheduling a subject visit. The second step is to generate a checklist and/or electronic source document or case report form automatically at the beginning of a subject visit. The third step is to notify at least one stakeholder at the beginning of a subject visit. A stakeholder is any one of a sponsor, a regulator, an investigator, a site, a patient, and a monitor or auditor. The fourth step is to alert at least one stakeholder if a scheduled visit is missed or cancelled. The fifth step is to alert at least one stakeholder before a scheduled subject visit to send a reminder to the subject regarding the upcoming study visit or associated procedures or laboratory tests. The sixth step is to generate a checklist to track proper compliance with follow-up procedures. The seventh and final step is to alert at least one stakeholder if the subject is dropped for exceeding a threshold of missed and cancelled visits.

A seventh embodiment of the present invention is a method for producing good clinical information within a system for managing clinical trials. The first step is to assure that the clinical information is collected in a regulatory compliant manner. Assuring the clinical information is collected in a regulatory compliant manner includes but is not limited to assuring consistency with regulations from one or more of the International Conference on Harmonization Good Clinical Practice, the Code of Federal Regulations, the Office of Human Research Protections, and the National Institutes of Health. The second step is to assure that the clinical information is collected in accordance with a proper organization workflow. Assuring that the clinical information is collected in accordance with a proper organization workflow includes but is not limited to one or more of integrating business rules, integrating clinical trials processes' connectivity, assuring proper sequencing of critical path elements, assuring proper change management, assuring proper logistics, and collecting the clinical information in accordance with the approved study protocol. The third step is to assure that the clinical information is collected according to a clinical trial critical path. The fourth step is to assure the data integrity of the clinical information. Assuring data integrity of the clinical information includes but is not limited to one or more of validating that the clinical information is accurate, determining that the clinical information is relevant to the study being conducted, assuring that the clinical information is in a standardized coding system, assuring that the clinical information is normalized, verifying that the clinical information is complete, assuring that the clinical information is uncorrupted, and assuring that the clinical information is unaltered. The fifth step is to assure the security of the clinical information. Assuring the security of the clinical information includes preventing access to the clinical information by unauthorized non-stakeholders. The final step is to assure the privacy of the clinical information. Assuring the privacy of the clinical information includes preventing access to the clinical information by unauthorized stakeholders.

An eighth embodiment of the present invention is a method for closing-out a clinical trial within a system for managing clinical trials. The first step is to provide a first report of the treatment allocation for all enrolled subjects. The second step is to provide a second report on all used and unused investigational products. The third step is to lock the clinical trial database after completion of all case report forms. The fourth step is to perform a final analysis on the locked clinical trial database. The fifth step is to notify at least one stakeholder of completion of the clinical trial. The sixth step is to draft a final clinical study report.

A ninth embodiment of the present invention is a method for presenting information to stakeholders within a system for managing clinical trials. The first step is to create a digital dashboard for a stakeholder. A stakeholder includes one of a sponsor, a regulator, an investigator, a site, a patient, and a monitor. The second step is to display a category of information common to all stakeholders on the digital dashboard. A category of information common to all stakeholders includes but is not limited to an email application, links to Web sites, references to trial information, announcements, and alerts. The final step is to display a category of information specific to the stakeholder on the digital dashboard. A category of information specific to a sponsor stakeholder includes but is not limited to study documents, site performance, action items, financial metrics, good will metrics, safety records, and sponsor performance metrics. A category of information specific to an investigator stakeholder included one or more of monitoring schedule, action items, monthly and daily schedule, site performance metrics, queries, milestones, and site adverse events. A category of information specific to a site stakeholder included one or more of monitoring schedule, action items, site statistics, site performance metrics, waiting response, safety training, pending investigational new drug reports, special handling information, efficacy summary, and safety summary. A category of information specific to a patient stakeholder includes one or more of investigator profile, information about the study disease, patient record, reminders, instructions, and study documents. A category of information specific to a monitor stakeholder includes one or more of multi-site monitoring, milestones, adverse events, action items, queries, and multi-site performance metrics.

### BRIEF DESCRIPTION OF THE DRAWINGS

FIG. 1 is an illustration of a known process for conducting clinical trials, and shows a number of weaknesses in the communication between elements as leaky pipes.

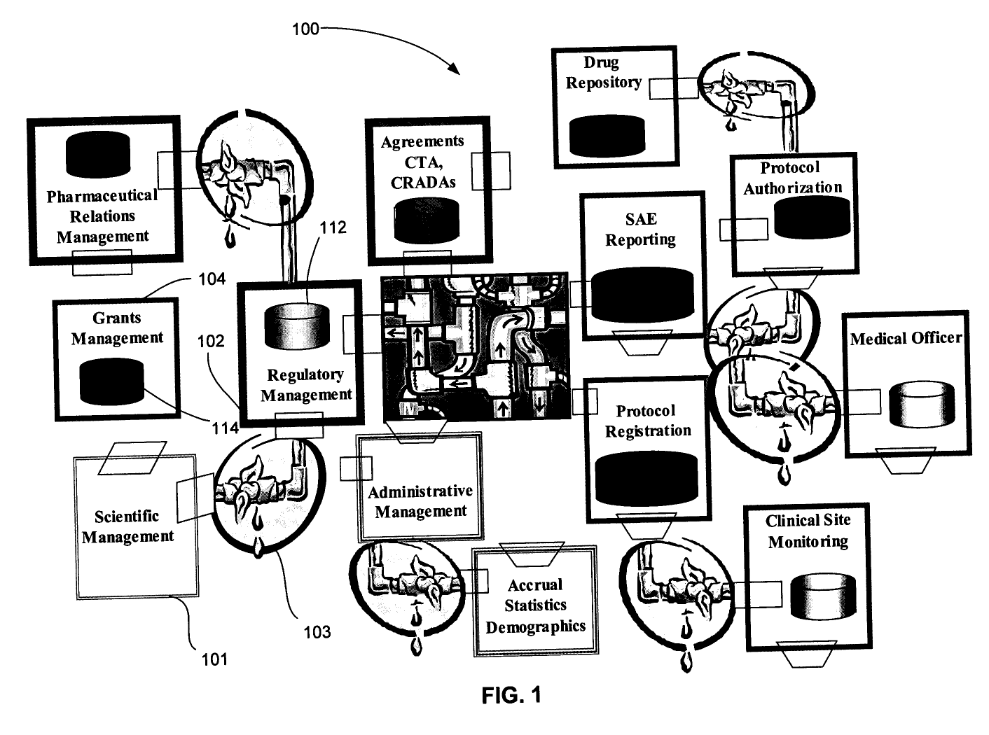

FIG. 2 is a schematic diagram showing an exemplary system for managing clinical trials in accordance with an embodiment of the present invention.

FIG. 3 is a schematic diagram showing an exemplary set of the types of applications containing core components running on a server in a system for managing clinical trials in accordance with an embodiment of the present invention.

FIG. 4 is a schematic diagram showing an exemplary set of the types of applications containing core and non-core components running on a server in a system for managing clinical trials in accordance with an embodiment of the present invention.

FIG. 5 is a schematic diagram showing an exemplary set of core components that can be executed as a trial design application in accordance with an embodiment of the present invention.

FIG. 6 is a schematic diagram showing an exemplary set of core and non-core components that can be executed as a trial design application in accordance with an embodiment of the present invention.

FIG. 7 is a schematic diagram showing an exemplary set of core components that can be executed as a trial conduct application in accordance with an embodiment of the present invention.

FIG. 8 is a schematic diagram showing an exemplary set of core and non-core components that can be executed as a trial conduct application in accordance with an embodiment of the present invention.

FIG. 9 is a schematic diagram showing an exemplary set of core components that can be executed as a trial monitoring application in accordance with an embodiment of the present invention.

FIG. 10 is a schematic diagram showing an exemplary set of core and non-core components that can be executed as a trial monitoring application in accordance with an embodiment of the present invention.

FIG. 11 is a schematic diagram showing an exemplary set of core components that can be executed as a trial analysis application in accordance with an embodiment of the present invention.

FIG. 12 is a schematic diagram showing an exemplary set of core and non-core components that can be executed as a trial analysis application in accordance with an embodiment of the present invention.

FIG. 13 is a schematic diagram showing an exemplary set of core components that can be executed as an applications interface application in accordance with an embodiment of the present invention.

FIG. 14 is a schematic diagram showing an exemplary set of core and non-core components that can be executed as an applications interface application in accordance with an embodiment of the present invention.

FIG. 15 is a schematic diagram showing an exemplary method for reporting clinical trials information within a system for managing clinical trials in accordance with an embodiment of the present invention.

FIG. 16 is a schematic diagram showing an exemplary method for monitoring events within a system for managing clinical trials in accordance with an embodiment of the present invention.

FIG. 17 is a schematic diagram showing an exemplary method for scheduling and tracking the appointments of a clinical trial subject within a system for managing clinical trials in accordance with an embodiment of the present invention.

FIG. 18 is a schematic diagram showing an exemplary method for assuring good clinical information in scheduling and tracking the appointments of a clinical trial subject within a system for managing clinical trials in accordance with an embodiment of the present invention.

FIG. 19 is a schematic diagram showing an exemplary method for alerting and reporting in scheduling and tracking the appointments of a clinical trial subject within a system for managing clinical trials in accordance with an embodiment of the present invention.

FIG. 20 is a schematic diagram showing an exemplary method for producing good clinical information within a system for managing clinical trials in accordance with an embodiment of the present invention.

FIG. 21 is a schematic diagram showing an exemplary method for closing-out a clinical trial within a system for managing clinical trials in accordance with an embodiment of the present invention.

FIG. 22 is a schematic diagram showing an exemplary method for presenting information to stakeholders within a system for managing clinical trials in accordance with an embodiment of the present invention.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

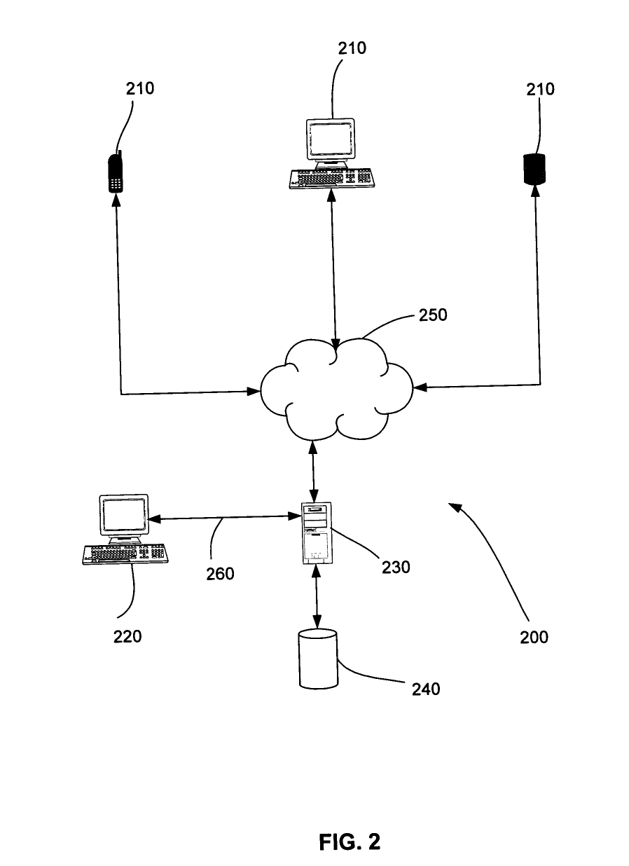

FIG. 2 is a schematic diagram showing an exemplary system for managing clinical trials in accordance with an embodiment of the present invention. System 200 includes web clients 210, client 220, server 230, and database 240. Web clients 210 access the Web via a Web browser. Web clients include, but are not limited to a computer, a cellular phone, and a PDA. Web clients 210 and client 220 access server 230. Web clients 210 access server 230 via Web connection 250. One skilled in the art will appreciate that a Web connection includes intranets, extranets, and the Internet. Client 220 accesses the server via connection 260, which is a connection other than a Web connection. One skilled in the art will appreciate that connection 260 can be any connection other that a connection over which a Web technology is used. This includes but is not limited an Internet connection, an Ethernet connection, and an application programming interface on the same computer. Client 220 includes but is not limited to a computer, a cellular phone, a PDA, and an application running on any of these devices. Client 220 may also be an external application on the server such as EXCEL™, ACCESS™, or WORD™.

Patient records database 240 can be accessed by the server via its applications. Through these applications patient records database 240 is logically partitioned and distributed based on the role in the clinical trials process of the user accessing the information. The roles of clinical trials users include but are not limited to sponsor, regulator, investigator, site, patient, and monitor.

Server 230 provides a number of different applications a user can run, depending on their role in the clinical trials process. These applications are divided into core and non-core components. Core components are those components required for minimal functionality of the system. Non-core components are additional applications that enhance the functionality of the system, but are not required.

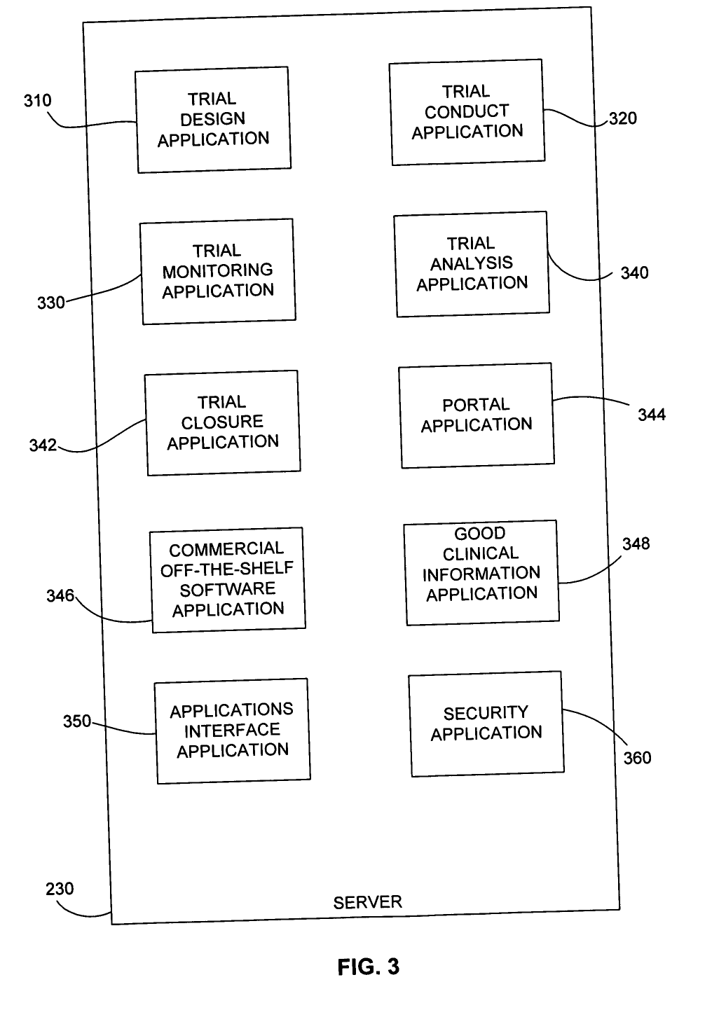

Both core and non-core components are divided into eleven different types of applications based on their function in the clinical trials process. FIG. 3 is a schematic diagram showing an exemplary set of the types of applications containing core components running on a server in a system for managing clinical trials in accordance with an embodiment of the present invention. These applications include but are not limited to trial design 310, trial conduct 320, trial monitoring 330, trial analysis 340, trial closure 342, portal 344, commercial off-the-shelf software 346, good clinical information 348, applications interface 350, security 360 applications, and trial submission 410 applications.

Trial design applications 310 allow the design, development, and customization of a clinical trial. Trial conduct applications 320 manage the ongoing operations of the clinical trial. Trial monitoring applications 330 provide information about the ongoing operations of the clinical trial at a moment of time during the clinical trial. Trial analysis applications 340 provide information about the results of the clinical trial up to the time the trial analysis application is accessed.

Trial closure application 342 contains one component. It is a core component. This component performs the necessary functions to close-out the clinical trial.

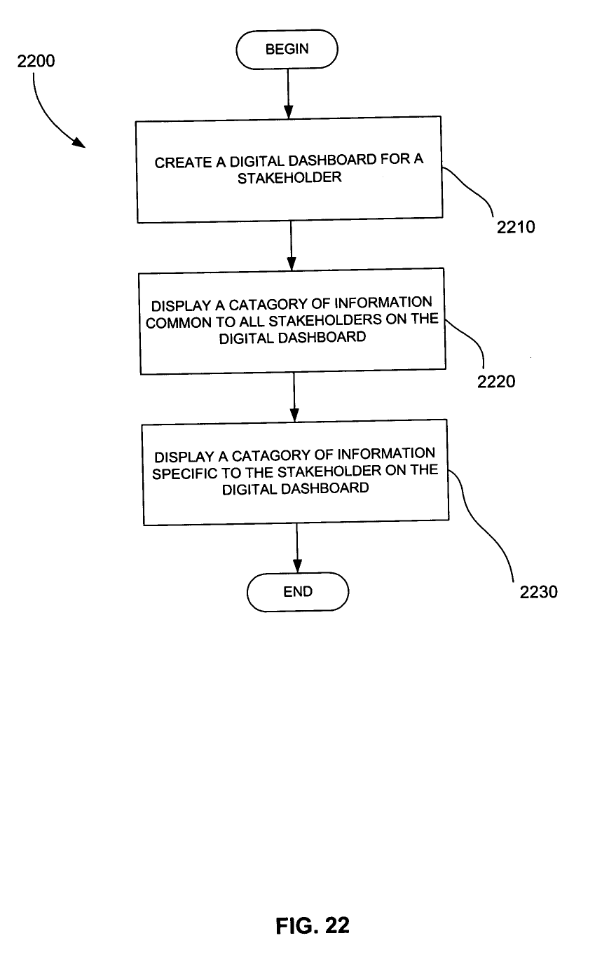

Portal application 344 contains one component. It is a core component. This component provides a user interface accessible through a Web connection. Architecturally, portal application 344 is, for example, a web server application running on server 230. In one embodiment, this application includes the methods of displaying the clinical trials information on a user's screen. One method involves the creation of a digital dashboard and is shown in FIG. 22.

Commercial off-the-shelf software application 346 contains one component. It is a core component. This component integrates external software used by the system. In one embodiment, this application makes calls to the programming interface of external software. In another embodiment, this application communicates with external software via an industry standard language such as XML.

Good clinical information application 348 contains one component. It is a core component. This component assures that collected data is compliant with industry regulations and standards, is in accordance with an organizational workflow and the clinical trial critical path, adheres to data integrity standards, and is maintained in accordance with security and privacy standards.

Applications interface applications 350 allow clients, who are connected to the system via a connection other than a Web connection, to access the system.

Security application 360 contains one component. It is a core component. This component allows for network security and user-defined password-protected access to the data. It also allows for the addition of further security, data integrity and privacy provisions adapters in accordance with client needs, industry standards and regulations. These standards and regulations include, for example, Health Level 7, 21 CFR Part 11, Health Insurance Portability and Accountability Act (1996), and American Society for Testing and Materials requirements.

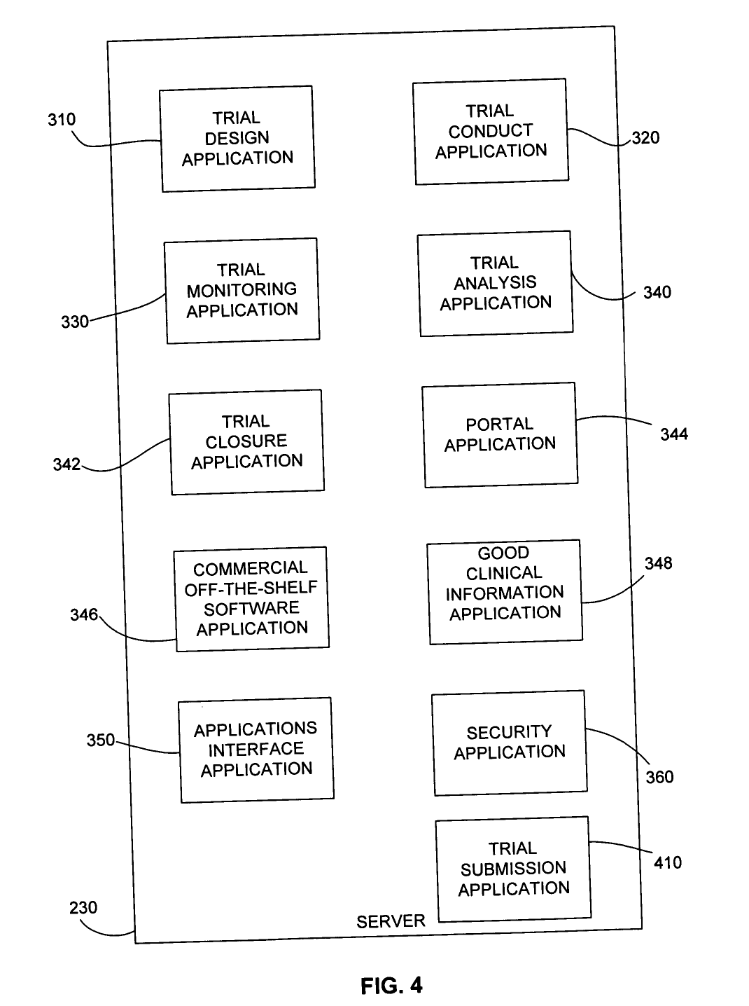

FIG. 4 is a schematic diagram showing an exemplary set of the types of applications containing core and non-core components running on a server in a system for managing clinical trials in accordance with an embodiment of the present invention. In addition to the types of applications shown in FIG. 3, FIG. 4 contains trial submission application 410. This application type contains only one component, referred to as the regulatory manager component, which is a non-core component. This component is designed to assist sponsors in assembling the information required for regulatory submissions, to manage Investigational New Drug (IND) and New Drug Application (NDA) submission requirements and to provide an interface for Data and Safety Monitoring Board (DSMB) and Institutional Review Board (IRB) reporting. Protocol specific regulatory requirements are incorporated into the functionality of this component to assist in regulatory decision support, drug development critical path planning and forecasting.

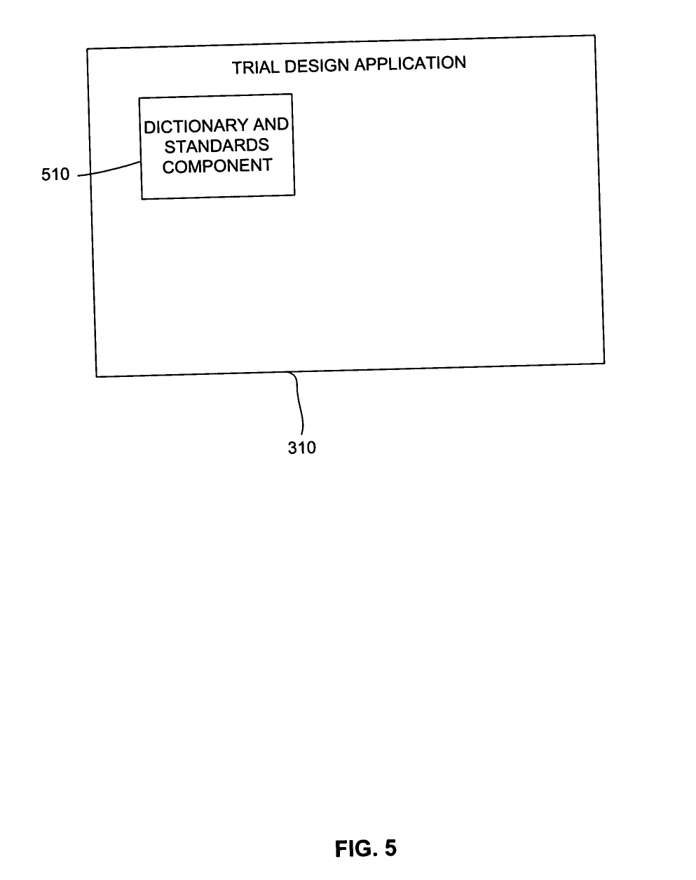

FIG. 5 is a schematic diagram showing an exemplary set of core components that can be executed as a trial design application in accordance with an embodiment of the present invention. Trial design application 310 contains only one core component. This component is dictionary and standards component 510. It enables interfaces between the system and relevant dictionaries and standards. These dictionaries and standards include but are not limited to common data elements, common toxicity criteria, MedDRA codes, ICD9/10 codes, IMT codes, and Common Data Interchange Standards Consortium.

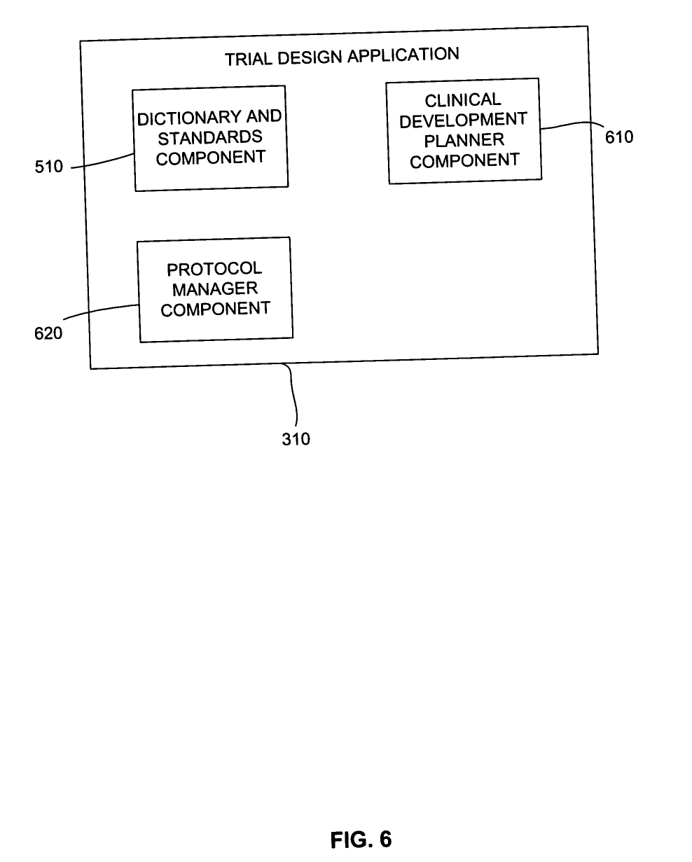

FIG. 6 is a schematic diagram showing an exemplary set of core and non-core components that can be executed as a trial design application in accordance with an embodiment of the present invention. In addition to the component shown in FIG. 5, FIG. 6 contains non-core components clinical development planner component 610 and protocol manage component 620.

Clinical development planner component 610 assists the user in the identification of candidates for development and assists in creating target product profiles. Based on a profile, the user utilizes this component to create development timeline, projected workflow, anticipated resources, applicable regulations and standards. This is then compared to actual resources and current states of compliance.

Protocol manager component 620 allows the definition of all elements of the clinical trial in a collaborative manner with tight document control. Once authored and approved, the protocol is implemented through an interface with multiple other components for the design of study-specific forms, for the definition of study personnel, and for trial setup activities.

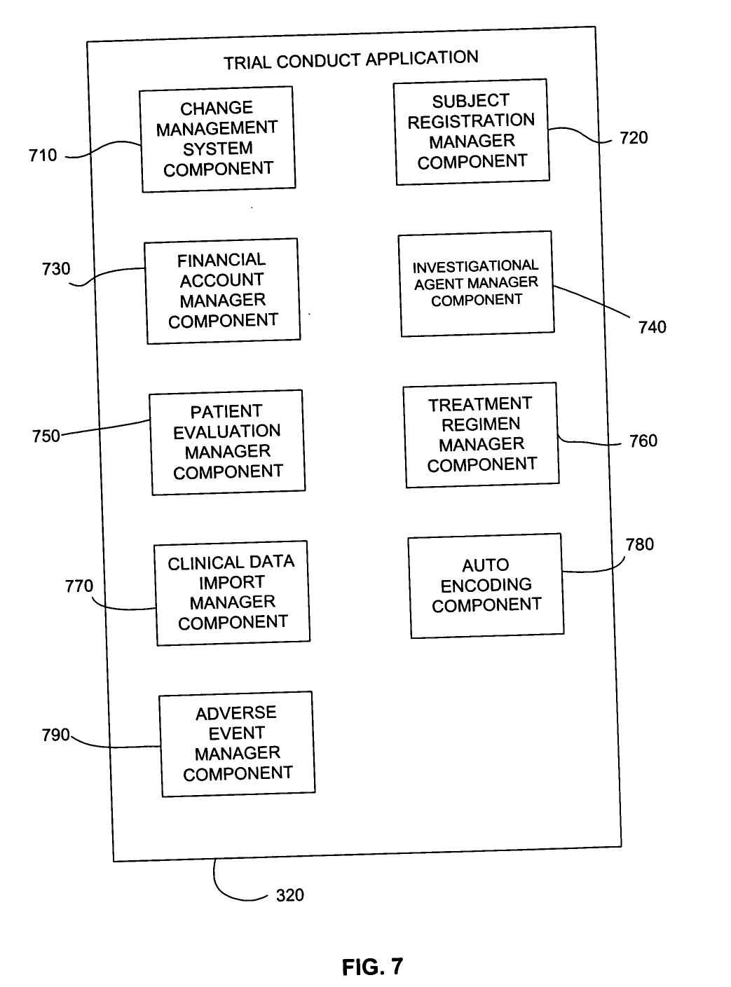

FIG. 7 is a schematic diagram showing an exemplary set of core components that can be executed as a trial conduct application in accordance with an embodiment of the present invention. Trial conduct application 320 contains nine core components.

Change management system component 710 allows for the implementation of clinical quality assurance and control through the ability to revise, version, and track modifications and approvals on controlled documents. These controlled documents include protocols, informed consents, case reports forms, investigative brochures, patient materials, and advertising and marketing materials. Additionally, this component allows study-wide alerts and implementation of revisions to include tracking the re-consent process.

Subject registration manager component 720 registers patients and profiles them against clinical trial inclusion and exclusion criteria for appropriate patient recruitment. It also allows for the collection of demographic, payer, referring physician, and emergency information as one portion of the complete clinical trial-related electronic medical record. Finally, it captures information about the referring physician. It does this for the purposes of evaluating investigative site performance, gathering patient population characteristics, and maintaining a two-way flow of information pertaining to the patients medical condition and progress through the trial

Financial account manager component 730 enables gate-keeping of medical billing information. In this way assures that appropriate billing practices are maintained throughout the clinical trial process. It also allows billing across multiple sites, multiple organizations, and consistency with the protocol as well as third party provider dictionaries and lists.

Investigation agent manager component 740 allows the capture of all drug distribution, tracking, disposition, accountability, transfer, and return in accordance with regulations and the clinical trial protocol. The capability exists to track the conditions during shipping and storage, and to report any deviations from recommended drug handling instructions.

Patient evaluation manager component 750 facilitates interpretive summaries, diagnosis code assignment, and treatment code assignment. This facilitation provides assurance of compliance with the clinical trial protocol, proper study visit documentation, streamlined serious adverse event reporting, and clinical outcome evaluation.

Treatment regimen manager component 760 allows for a standardized mechanism for treatment courses and dose escalations. These courses and escalations are in accordance with algorithms that are configured according to the clinical trial protocol. This minimizes medication dose errors and treatment arm assignment errors.

Clinical data import manager component 770 allows the system to interface with radiology imaging systems for the import of radiographic data and diagnostic interpretations, medical information systems for the import of medical data, and medical information systems for the import of laboratory data for the clinical trial.

Auto encoding component 780 codes disease categories and toxicity data through access to current global libraries and coding algorithms.

Adverse event manager component 790 collects and tracks all adverse events in the clinical trial process. This component will assist the investigative site, sponsor and regulator in reporting and tracking serious adverse events and in general safety monitoring. Decision support is provided and based upon data entered, one of several critical paths will be recommended. The user will be prompted for the appropriate selection based on the severity, attribution and other protocol-specific criteria. Once a critical path for reporting is selected, the user will be prompted to complete critical steps in the process. The user is assisted in creating and completing a report and appropriate submission, either to the sponsor or to the Food and Drug Administration (FDA). Other oversight bodies for reporting is configured in a protocol-specific manner and required reports automatically generated. Serious Adverse Event (SAE) data is also be summarized for interim and final reports.

All toxicity adverse events are subjected to a standardized method of coding adverse events as they are collected and routed promptly to this component if they meet the criteria for serious adverse event or expedited reporting. This is done using Common Toxicity Criteria (CTC) v2.0 and v3.0. Through this component sponsors are able to reconcile adverse events with clinical data for final report preparation. Each Adverse Event (AE) will have a unique number and will be tracked. Therefore if it evolves or devolves from AE to SAE or back, the identifier will link the two AEs and identify them as being varying severities of the same AE.

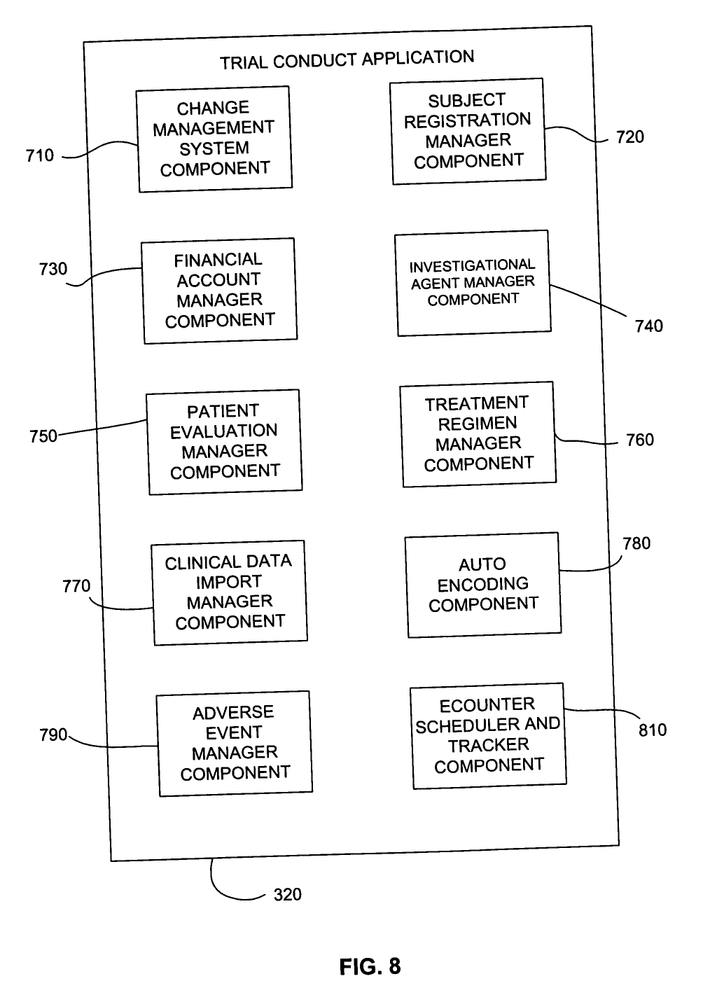

FIG. 8 is a schematic diagram showing an exemplary set of core and non-core components that can be executed as a trial conduct application in accordance with an embodiment of the present invention. In addition to the components shown in FIG. 7, FIG. 8 contains one non-core component.

Encounter scheduler and tracker component 810 integrates the scheduling of clinical trial-related visits with routine physician office visits. Based on protocol criteria and schedule it manages scheduled and unscheduled visits, triggers reminders of visit windows, and prompts completion of visit-specific procedures and capture of specific information. During the study visit, the physician-patient encounter is captured in real-time and the data obtained is compared against protocol criteria to alert or prompt for missing or inaccurate information. This component incorporates all regulations and standards in a protocol-specific manner to promote regulatory compliance.

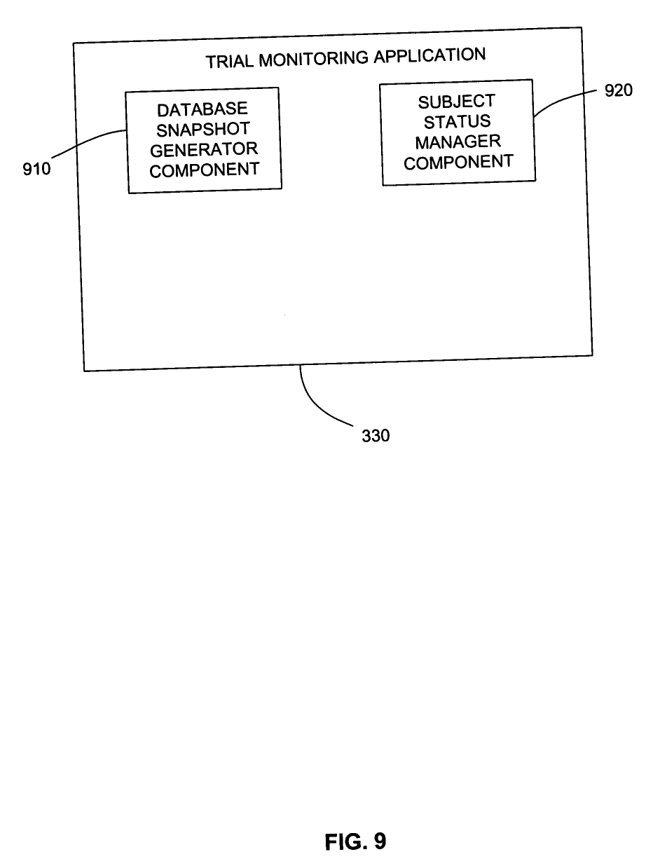

FIG. 9 is a schematic diagram showing an exemplary set of core components that can be executed as a trial monitoring application in accordance with an embodiment of the present invention. Trial monitoring application 330 contains two core components.

Database snapshot generator component 910 enables access to data for real-time clinical trial status monitoring at definable intervals for resource allocation, trend analysis, decision support, and interim analysis. Subject status manager component 920 ascertains the status of all subjects in the clinical trial and captures the reasons subjects leave the clinical trial. When patients go off-study, the reason is captured in accordance with Good Clinical Practice (GCP). This component also assures that the data from such patients is not included in the final study report except as required by regulations.

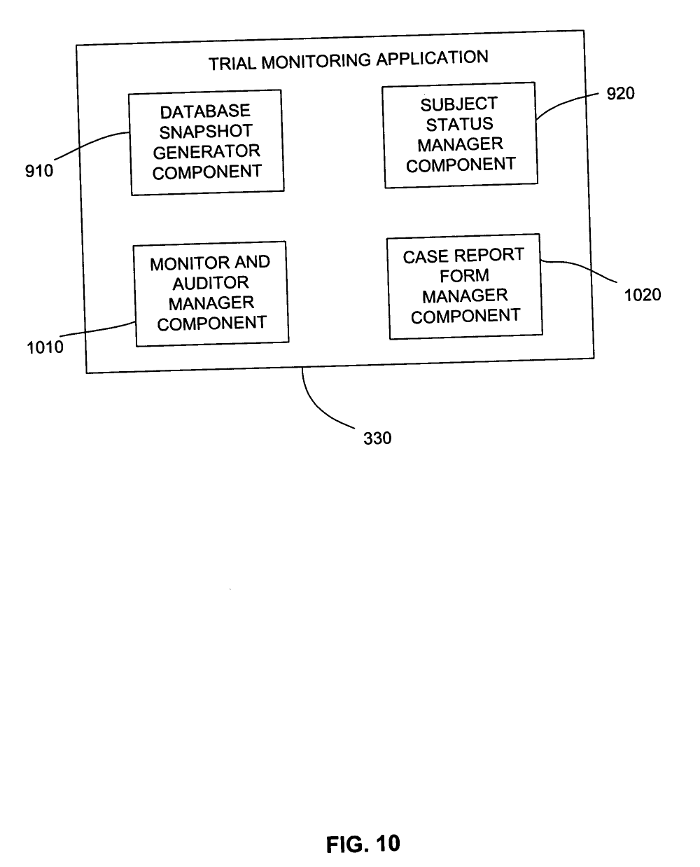

FIG. 10 is a schematic diagram showing an exemplary set of core and non-core components that can be executed as a trial monitoring application in accordance with an embodiment of the present invention. In addition to the components shown in FIG. 9, FIG. 10 contains two non-core components.

Monitor and auditor manager component 1010 assures compliance with regulations requiring specific monitoring and auditing of the clinical trial process. Case report form manager component 1020 allows the design and tracking of paper and electronic case report forms. It also allows a structured design and review process to be configured to the client's processes. Once designed and approved, the forms are deployed to the application server. This component also includes functionality for tracking paper and electronic case report forms and is designed for use in non-Electronic Data Capture (EDC) or hybrid clinical trials environments which represent the majority of clinical trials at present. Through this component, investigative sites and sponsors can coordinate case report form monitoring and tracking.

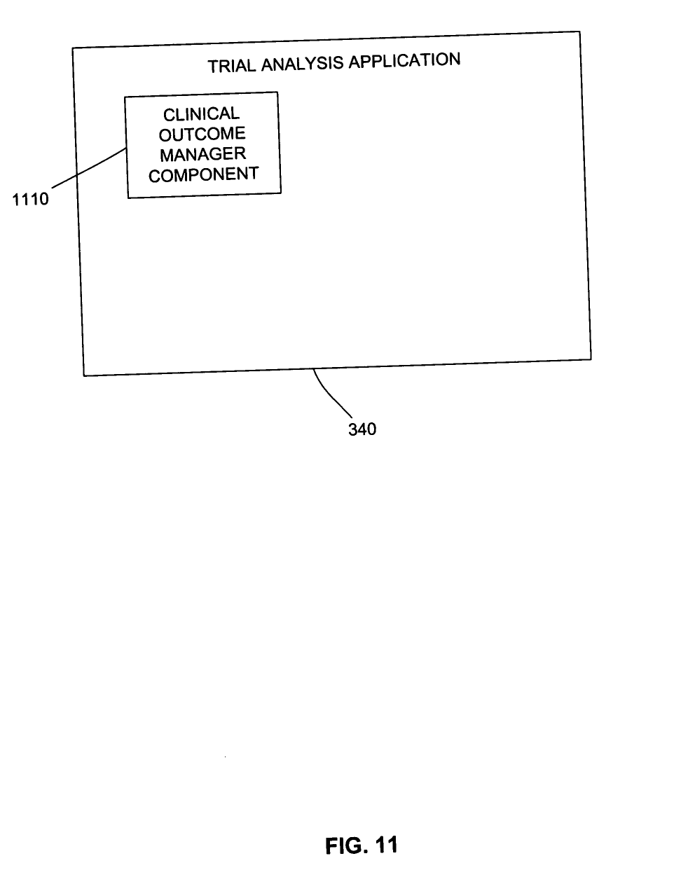

FIG. 11 is a schematic diagram showing an exemplary set of core components that can be executed as a trial analysis application in accordance with an embodiment of the present invention. Trial analysis application 340 contains one core component. Clinical outcome manager component 1110 generates interim and final clinical trial status reports.

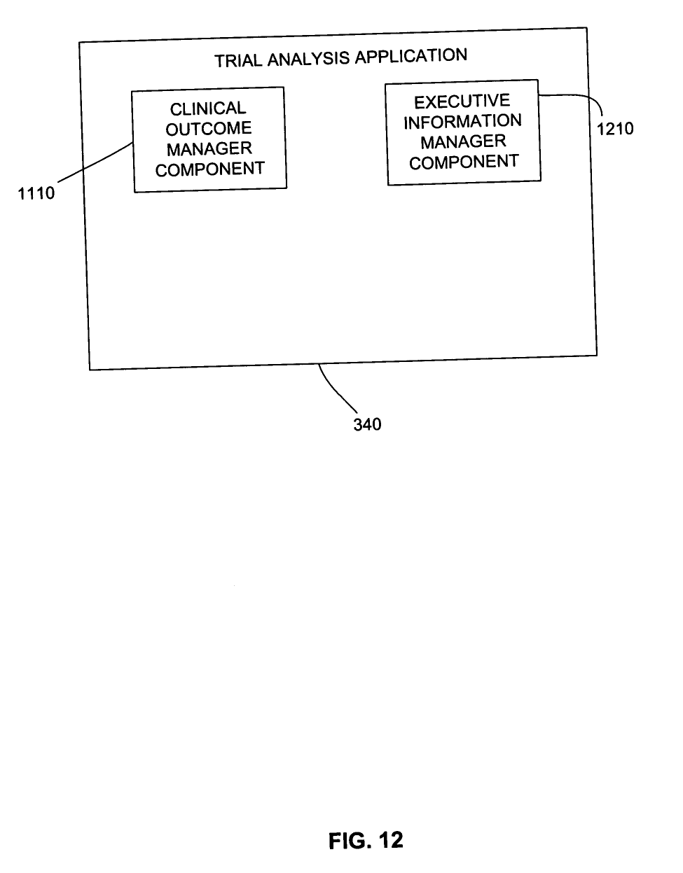

FIG. 12 is a schematic diagram showing an exemplary set of core and non-core components that can be executed as a trial analysis application in accordance with an embodiment of the present invention. In addition to the component shown in FIG. 11, FIG. 12 contains one non-core component. Executive information manager component 1210 allows for the monitoring of key executive vital signs, data analysis, and business intelligence.

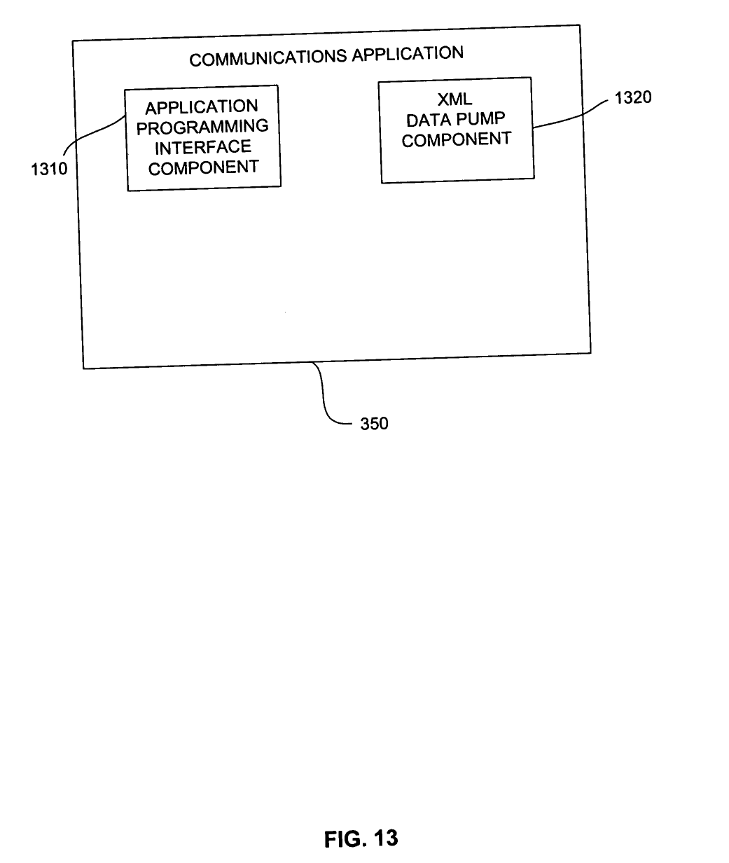

FIG. 13 is a schematic diagram showing an exemplary set of core components that can be executed as an applications interface application in accordance with an embodiment of the present invention. Applications interface application 350 contains two core components.

Application programming interface component 1310 enables external applications to communicate with the system. XML Data Pump component 1320 allows import and export of data in XML format to and from the patient records database.

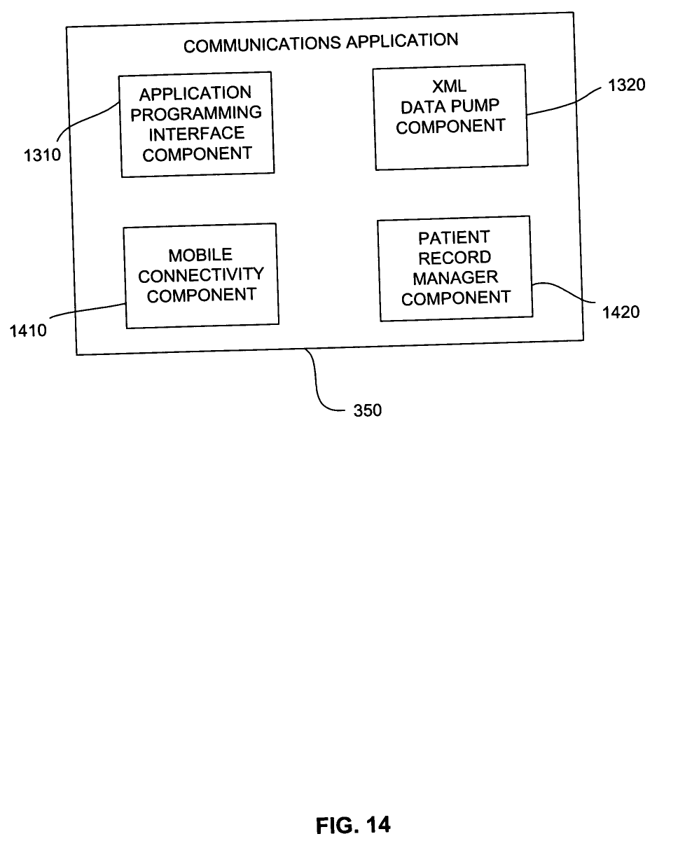

FIG. 14 is a schematic diagram showing an exemplary set of core and non-core components that can be executed as an applications interface application in accordance with an embodiment of the present invention. In addition to the components shown in FIG. 13, FIG. 14 contains two non-core components.

Mobile connectivity component 1410 allows stakeholders to enter information and receive real-time alerts via mobile devices. In other words, this component allows mobile devices to act as a true client. The system uses this component to call, page, or test message a stakeholder, for example.

Patient records manager component 1420 allows external electronic medical records to be added to the clinical trial process. This provides the system with demographic information.

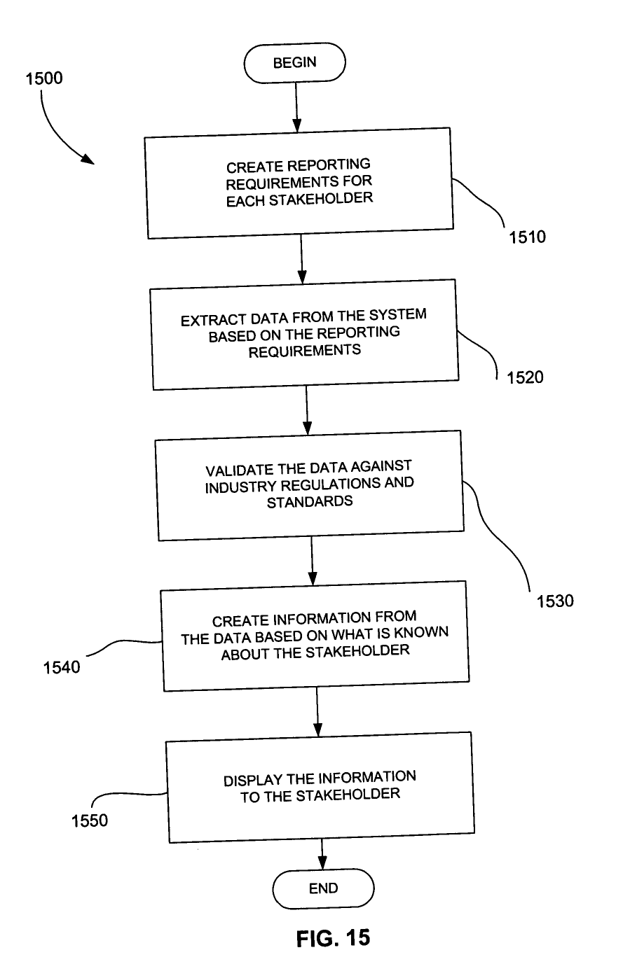

FIG. 15 is a schematic diagram showing an exemplary method for reporting clinical trials information within a system for managing clinical trials in accordance with an embodiment of the present invention.

In step 1510 of method 1500, the reporting requirements for a stakeholder are created. A stakeholder is a sponsor, a regulator, an investigator, a site, a patient, or a monitor.

In step 1520, data is extracted from the system based on the reporting requirements.

In step 1530, the data is validated against regulations and standards.

In step 1540, information is created from the data based on what is known about the stakeholder. For example, if it is known that this particular stakeholder looked at similar data on an earlier date, that data may be automatically plotted and compared to the current data.

Finally in step 1550, the information created is displayed to the stakeholder.

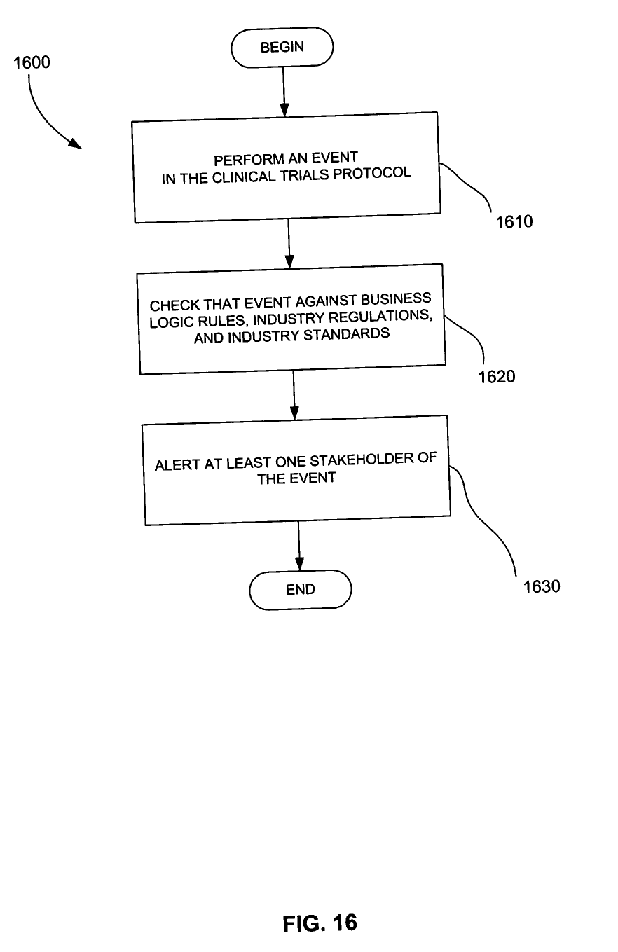

FIG. 16 is a schematic diagram showing an exemplary method for monitoring events within a system for managing clinical trials in accordance with an embodiment of the present invention. This method shows the advantage of having a system for managing clinical trials. After each event in the clinical trials process, this event can be checked against industry regulations and standards, and any of the stakeholders can be alerted to the event.

In step 1610 of method 1600, an event is performed in the clinical trials protocol.

In step 1620 that event is checked against business logic rules, industry regulations, and industry standards.

Finally in step 1630, at least one stakeholder is alerted of the event.

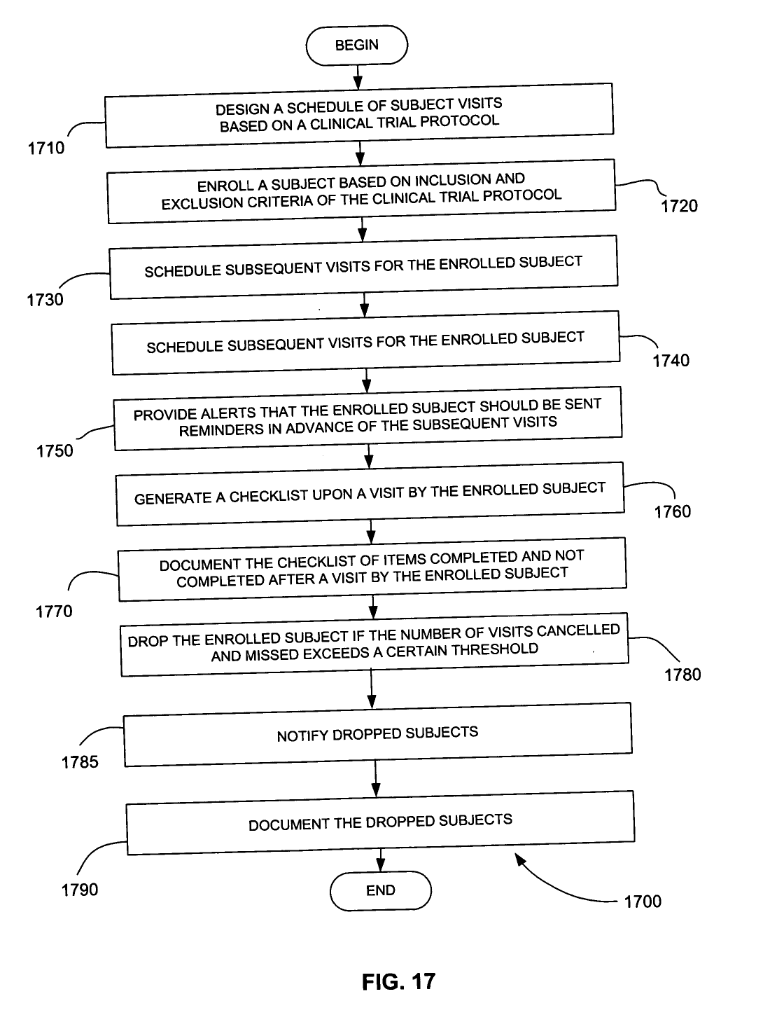

FIG. 17 is a schematic diagram showing an exemplary method for scheduling and tracking the appointments of a clinical trial subject within a system for managing clinical trials in accordance with an embodiment of the present invention.

In step 1710 of method 1700 a schedule of subject visits based on the clinical trial protocol is designed.

In step 1720, a subject is enrolled based on the inclusion and exclusion criteria of the clinical trial protocol.

In step 1730, subsequent visits for the enrolled subject are automatically scheduled. A subsequent visit includes an office visit, a laboratory test, an x-ray, a procedure or preparation for a procedure.

In step 1740, alerts that the enrolled subject should be sent reminders in advance of the subsequent visits are generated.

In step 1750, a checklist is generated upon a visit by an enrolled subject. Items to be checked on a checklist include prompted the principal investigator review and signature, generated patient instructions, generated a coordinator checklist, checked laboratory results, check pathology results, checked microbiology results, and checked study reports.

In step 1760, the checklist of items completed and not completed after the visit by the enrolled subject is documented.

In step 1770, the cancelled and missed visits by an enrolled subject are documented.

In step 1780, the enrolled subject is dropped from the clinical trial if the number of visits cancelled or missed exceeds a threshold. This threshold is 3 missed visits.

In step 1785, the dropped subject is notified. This notification may be by certified letter.

In step 1790, the dropping of an enrolled subject is documented.

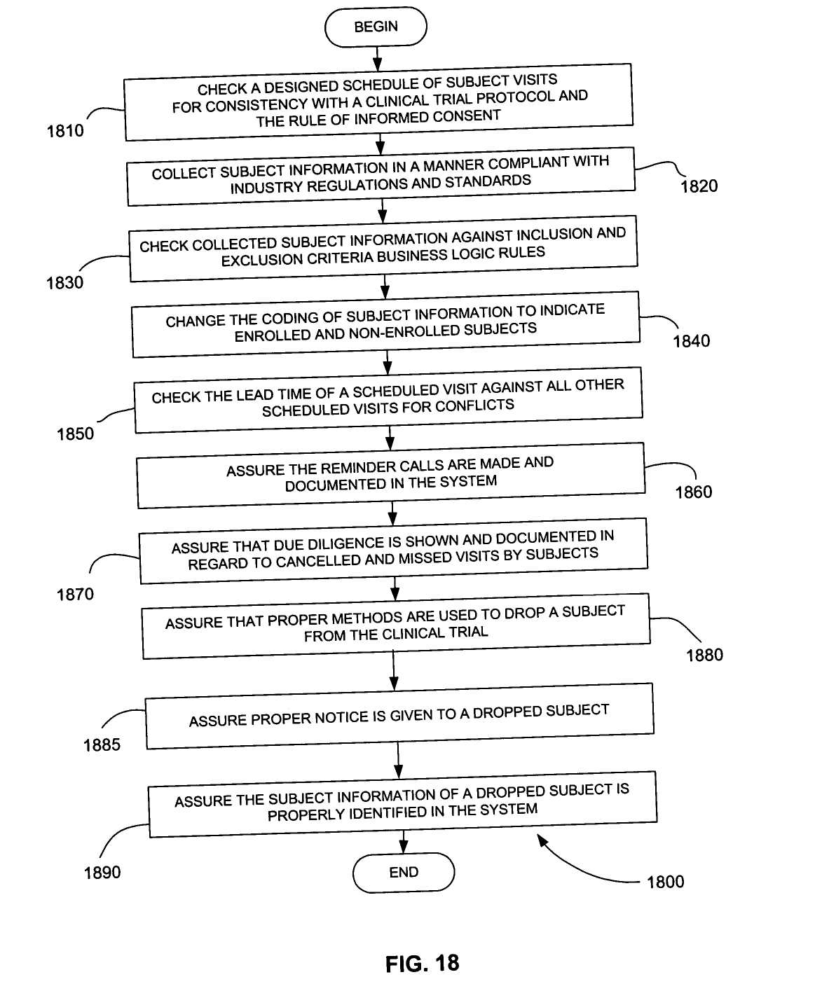

FIG. 18 is a schematic diagram showing an exemplary method for assuring good clinical information in scheduling and tracking the appointments of a clinical trial subject within a system for managing clinical trials in accordance with an embodiment of the present invention.

In step 1810 of method 1800, a designed schedule of subject visits is checked for consistency with a clinical trial protocol and the rules of informed consent.

In step 1820, subject information is collected in a manner compliant with industry regulations and standards.

In step 1830, the collected subject information is checked against inclusion and exclusion criteria business logic rules.

In step 1840, the coding of subject information is changed to indicate enrolled and non-enrolled subjects.

In step 1850, the lead time of a scheduled visit is checked against all other scheduled visits for conflicts.

In step 1860 assurance is provided that reminder calls are made and documented in the system.

In step 1870, assurance is provided that due diligence is shown and documented in regard to cancelled and missed visits by subjects.

In step 1880, assurance is provided that proper methods are used to drop a subject from the clinical trial.

In step 1885, assurance is provided that proper notice is given to a dropped subject.

In the final step 1890, assurance is provided that the subject information of a dropped subject is properly identified in the system.

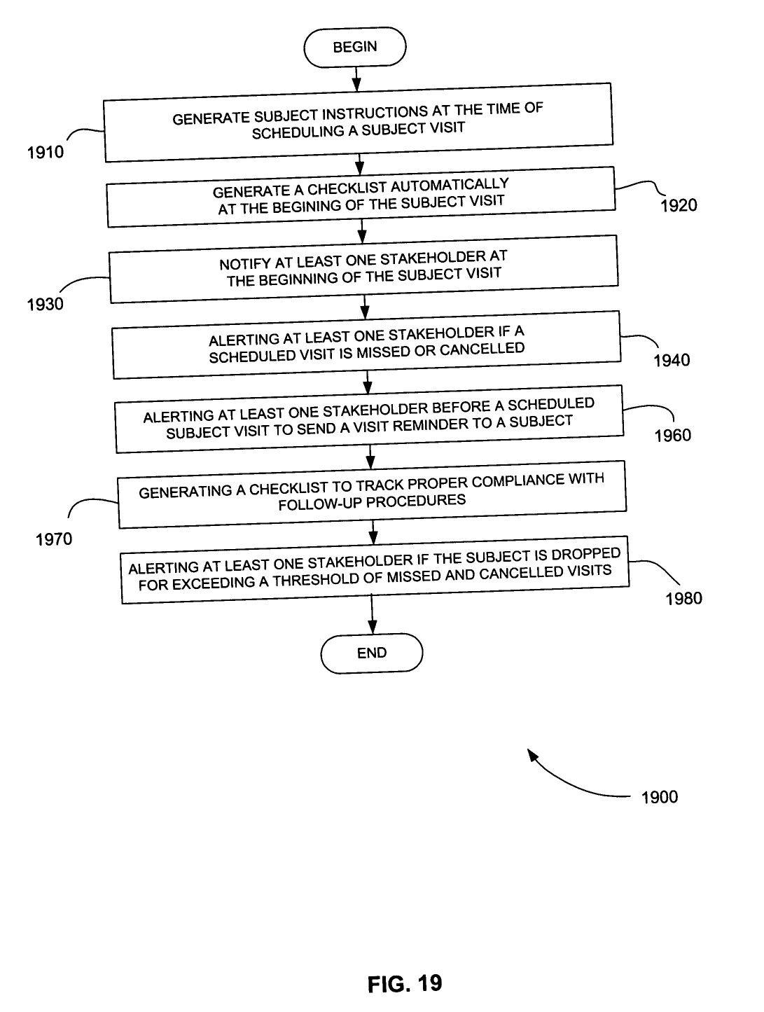

FIG. 19 is a schematic diagram showing an exemplary method for alerting and reporting in scheduling and tracking the appointments of a clinical trial subject within a system for managing clinical trials in accordance with an embodiment of the present invention.

In step 1910 of method 1900, subject instructions are generated at the time of scheduling a subject visit.

In step 1920, a checklist, an electronic source document or electronic case report form is generated automatically at the beginning of a subject visit.

In step 1930, at least one stakeholder is notified at the beginning of a subject visit. A stakeholder is any one of a sponsor, a regulator, an investigator, a site, a patient, and a monitor or auditor.

In step 1940, at least one stakeholder is alerted if a scheduled visit is missed or cancelled.

In step 1960, at least one stakeholder is alerted before a scheduled subject visit to send a reminder to the subject regarding upcoming visits, required procedures or laboratory tests.

In step 1970, a checklist is generated to track proper compliance with follow-up procedures.

In the final step 1980, at least one stakeholder is alerted if the subject is dropped for exceeding a threshold of missed and cancelled visits.

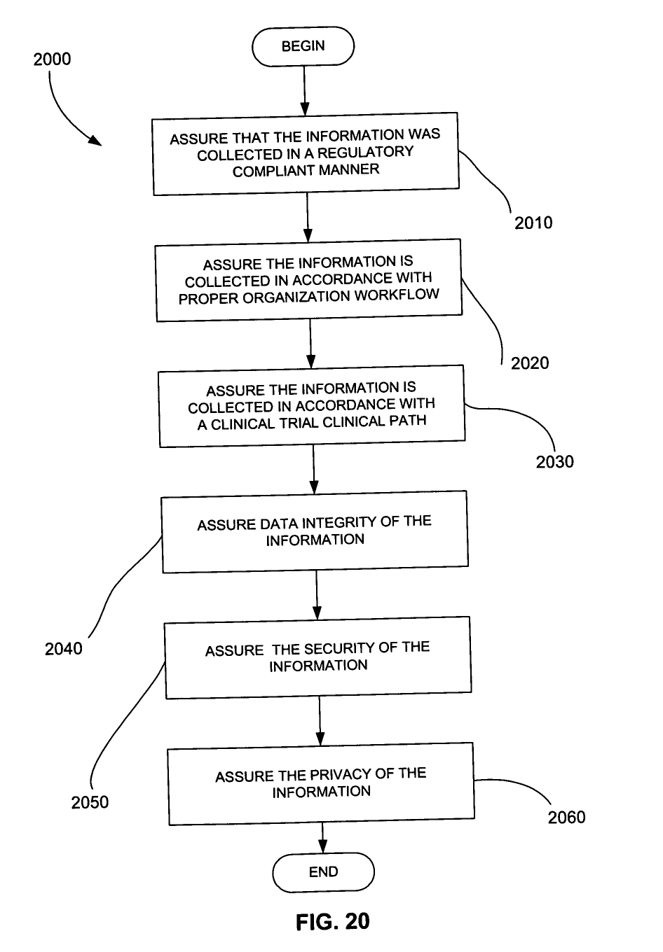

FIG. 20 is a schematic diagram showing an exemplary method for producing good clinical information within a system for managing clinical trials in accordance with an embodiment of the present invention.

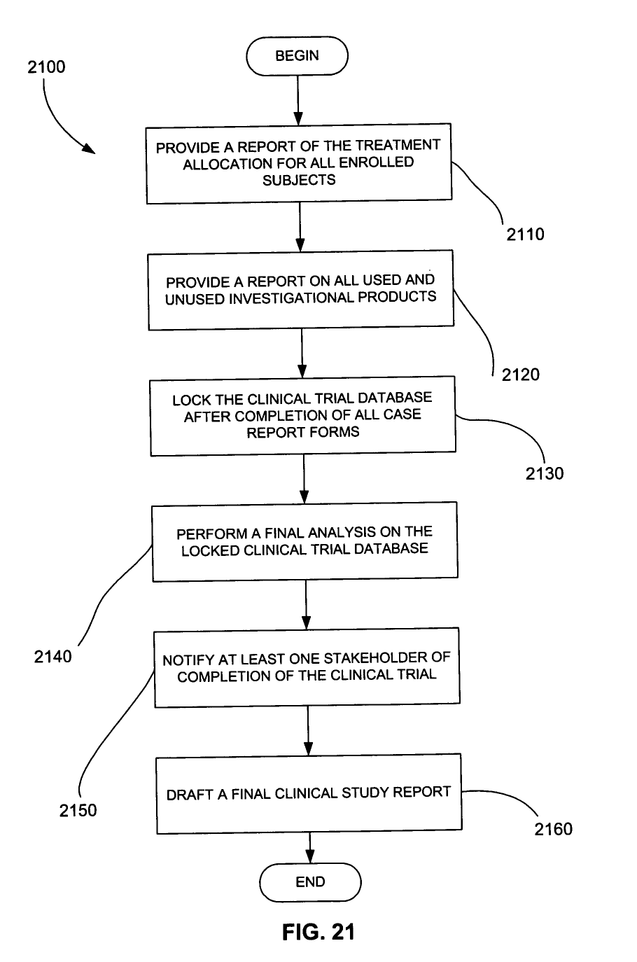

FIG. 21 is a schematic diagram showing an exemplary method for closing-out a clinical trial within a system for managing clinical trials in accordance with an embodiment of the present invention.

FIG. 20 is a schematic diagram showing an exemplary method for producing good clinical information within a system for managing clinical trials in accordance with an embodiment of the present invention. Sponsors and regulators of clinical trials rely on good clinical information to gain insights, make life-critical decisions, and manage every facet of a trial. Web-based access to the warehoused good clinical information enables real-time safety monitoring, analyses, reporting, and decision making with the total confidence that all the information is “clinically and scientifically sound”. Good clinical information is the informatics complement of FDA-mandated GCP (Good Clinical Practice). Both are essential in today's good clinical trials in order to ensure patient safety and high quality research.

In step 2010 of method 2000, assurance is provided that the clinical trial information was collected in a regulatory compliant manner. This involves assuring consistency with regulations from one or more of the International Conference on Harmonization Good Clinical Practice, the Code of Federal Regulations, the Office of Human Research Protections, and the National Institutes of Health.

In step 2020, assurance is provided that the clinical trial information is collected in accordance with a proper organization workflow. Assuring that the information is collected in accordance with a proper organization workflow includes but is not limited to one or more of integrating business rules, integrating clinical trials processes' connectivity, assuring proper sequencing of critical path elements, assuring proper change management, assuring proper logistics, and collecting the information in accordance with the approved study protocol.

In step 2030, assurance is provided that the clinical trial information is collected in accordance with a clinical trial critical path.

In step 2040, the data integrity of the information is assured. Assuring data integrity of the information includes but is not limited to one or more of validating that the information is accurate, determining that the information is relevant to the study being conducted, assuring that the information is in a standardized coding system, assuring that the information is normalized, verifying that the information is complete, assuring that the information is uncorrupted, and assuring that the information is unaltered.

In step 2050, the security of the information is asurred. Assuring the security of the information includes preventing access to the information by unauthorized non-stakeholders.

In the final step 2060, the privacy of the information is assured. Assuring the privacy of the information includes preventing access to the information by unauthorized stakeholders.

FIG. 21 is a schematic diagram showing an exemplary method for closing-out a clinical trial within a system for managing clinical trials in accordance with an embodiment of the present invention. After completion or termination of the trial, a number of functions must be performed to close-out the study.

In step 2110 of method 2100, a report of the treatment allocation for all enrolled subjects is provided. All subjects must have completed all study visits and follow up. A listing of the treatment allocation for all enrolled and consented subjects must be documented.

In step 2120, a report on all used and unused investigational products is provided. Documentation must reflect that study drug was collected from all subjects and that all unused product and used containers were collected and returned to the sponsor in the manner specified. A final close-out of the investigational product inventory, accountability, destruction and reconciliation must occur for each site and be appropriately documented. Copies of the drug log, final inventory and return documents are filed in the virtual regulatory binder.

In step 2130, the clinical trial database is locked after completion of all case report forms. All data and case report forms must be completed and collected for subjects enrolled in the clinical trial. All queries (data corrections and verifications) on this data must be resolved and the final data entered into the database. Once this has occurred, the database can be locked (or frozen).

In step 2140, a final analysis is performed on the locked clinical trial database. Before this analysis the data must be cleaned in a manner that does not alter the data. The data cleaning removes all information not relevant to the clinical trial.

In step 2150, at least one stakeholder is notified of the completion of the clinical trial. The study staff is notified in writing of the completion of study subject participation. A note indicating the cessation of a subject's participation in the clinical trial is entered into the subject's medical record, where appropriate. The principal investigator sends a written communication to the IRB to notify them that the study has closed and includes a short summary of the conclusion of the study, any serious adverse events that occurred during the conduct of the study and the significance they had upon the conclusions of the trial. The principal investigator notifies any other oversight bodies of the conclusion of the trial in accordance with their requirements. Copies of all such notifications are filed in the regulatory binder (virtual). All study related documentation, including copies of the source documents, case report forms and regulatory binder are retained in accordance with GCP “Study Records Retention and Storage”. The sponsor is notified of the location of these documents. All sponsor-required reports are completed and a copy of each is filed in the regulatory binder (virtual). An audit certificate or a final trial closeout monitoring report must be obtained for each investigative site.

Finally in step 2160, a final clinical study report is drafted. This report is then reviewed and finalized. Under specific circumstances the final study report is submitted to a regulatory authority.

FIG. 22 is a schematic diagram showing an exemplary method for presenting information to stakeholders within a system for managing clinical trials in accordance with an embodiment of the present invention.

In step 2210 of method 2200, a digital dashboard is created for a stakeholder. A stakeholder includes one of a sponsor, a regulator, an investigator, a site, a patient, and a monitor.

The role of senior managers in today's business environment has changed dramatically from a decade ago. As opportunities evolve faster, and the mandate to do more with the same or fewer resources, managers must have greater visibility into the full range of business processes and real-time results than ever before.

They can no longer wait for manually produced reports—they need to monitor their businesses continuously, getting instant alerts about problems and opportunities as they arise and before they become critical. They need to be able to access precise information in actionable forms precisely when they need it. Executive dashboards provide this by presenting key business performance data in concise report and graphical formats that create rapid understanding of current activities and point to possible remediation strategies when performance is non-optimal.

Managers can use dashboards to monitor divisions, track project progress, evaluate potential opportunities, training, measure the performance of the human capital, and monitor costs against expectations. Executive Dashboards (ED) are designed to provide a single point of entry where users can access and summarized data that is pertinent and relevant to the decisions that must be made to improve performance.

Prior to the availability of ED's, key decision makers were provided information using traditional electronic mechanisms such as spreadsheets, WORD™ documents or PDF™ files. Information in this form was useful but it was not provided in real-time and its presentation often made interpretation difficult. It is important recognize that to communicate data and information and deliver the message and information more effectively, visualization tools can often help.

An ED in one embodiment of the present invention presents inform in five different areas. These are communication and collaboration (i.e. email, calendars), data mining, monitoring and performance management, business intelligence, and decision support.

In step 2220, a category of information common to all stakeholders is displayed on the digital dashboard. A category of information common to all stakeholders includes but is not limited to an email application, links to Web sites, references to trial information, announcements, and alerts.

In the final step 2230, a category of information specific to the stakeholder is displayed on the digital dashboard. A category of information specific to a sponsor stakeholder includes but is not limited to study documents, site performance, action items, financial metrics, good will metrics, safety records, and sponsor performance metrics. A category of information specific to an investigator stakeholder included one or more of monitoring schedule, action items, monthly and daily schedule, site performance metrics, queries, milestones, and site adverse events. A category of information specific to a site stakeholder included one or more of monitoring schedule, action items, site statistics, site performance metrics, waiting response, safety training, pending investigational new drug reports, special handling information, efficacy summary, and safety summary. A category of information specific to a patient stakeholder includes one or more of investigator profile, information about the study disease, patient record, reminders, instructions, and study documents. A category of information specific to a monitor stakeholder includes one or more of multi-site monitoring, milestones, adverse events, action items, queries, and multi-site performance metrics.

Embodiments of the present invention relate to data communications via one or more networks. The data communications can be carried by one or more communications channels of the one or more networks. A network can include wired communication links (e.g., coaxial cable, copper wires, optical fibers, a combination thereof, and so on), wireless communication links (e.g., satellite communication links, terrestrial wireless communication links, satellite-to-terrestrial communication links, a combination thereof, and so on), or a combination thereof. A communications link can include one or more communications channels, where a communications channel carries communications. For example, a communications link can include multiplexed communications channels, such as time division multiplexing (“TDM”) channels, frequency division multiplexing (“FDM”) channels, code division multiplexing (“CDM”) channels, wave division multiplexing (“WDM”) channels, a combination thereof, and so on.

In accordance with an embodiment of the present invention, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

Systems and methods in accordance with an embodiment of the present invention disclosed herein can advantageously improve the clinical trials process in a number of ways. They can reduce trial deployment time and training costs. They can streamline patient recruitment and enrollment. They can enable faster reporting while improving the quality of clinical data. Finally, they can enhance communication among all of the key stakeholders conducting a clinical trial

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for managing clinical trials, the system comprising:
a Web client, wherein the Web client can access the Web via a Web browser;
a client;
a server, wherein the Web client can access the server via a Web connection and the client can access the server via a connection other than the Web connection; and
a patient records database, wherein the patient records database can be accessed by the server and the patient records database is logically partitioned and distributed based on a role in the clinical trials process of a user accessing the information.

2. The system of claim 1, wherein the Web client comprises one or more of a computer, a cellular telephone, and a personal data assistant.

3. The system of claim 1, wherein the client comprises one or more of a computer, a cellular telephone, and a personal data assistant.

4. The system of claim 1, wherein the user comprises one of sponsor, regulator, investigator, site, patient, and monitor.

5. The system of claim 1, wherein the server provides applications one or more of comprising:
a trial design application, wherein the trial design application allows a clinical trial to be designed, developed, and customized;
a trial conduct application, wherein the trial conduct application manages ongoing operations of the clinical trial;
a trial monitoring application, wherein the trial monitoring application provides information about the ongoing operations of the clinical trial at a moment in time during the clinical trial;
a trial analysis application, wherein the trial analysis application provides information about the results of the clinical trial up to the time the trial analysis application is accessed;
a trial closure application, wherein the trial closure application performs a function to close-out the clinical trial;
a portal application, wherein the portal application provides a user interface accessible through the Web connection;
a commercial off-the-shelf software application, wherein the commercial off-the-shelf software application integrates external software used by the system;
a good clinical information application, wherein the good clinical information application assures that collected data is compliant with industry regulations and standards, is in accordance with an organizational workflow and the clinical trial critical path, adheres to data integrity standards, and is maintained in accordance with security and privacy standards;
an applications interface application, wherein the applications interface application allows the client to access the system; and
a security application, wherein the security application allows user-defined password-protected access to the data and assures the security and integrity of the data while maintaining the compatibility with industry standards and regulations.

6. The system of claim 5, further comprising a trial submission application, wherein the trial submission application assembles information required for regulatory submissions and generates reports for regulatory reporting.

7. The system of claim 5, wherein the industry standards and regulations comprise one or more of the Health Level 7, 21 CFR Part 11, Health Insurance Portability and Accountability Act (1996), and American Society for Testing and Materials requirements.

8. The system of claim 5, wherein the trial design application comprises a dictionary and standards component, wherein the dictionary and standards component enables interfaces between the system and relevant dictionaries and standards comprising one or more of common data elements, common toxicity criteria, MedDRA codes, ICD9/10 codes, IMT codes, and Common Data Interchange Standards Consortium.

9. The system of claim 7, wherein the trial design application further comprises a clinical development planner component, wherein the clinical development planner component assists in identification of clinical trial candidates for development and helps in creating target product profiles.

10. The system of claim 7, wherein the trial design application further comprises a protocol manager component, wherein the protocol manager component allows the definition of all elements of the clinical trial in a collaborative manner with tight document control.

11. The system of claim 5, wherein the trial conduct application comprises one or more of:
a change management system component, wherein the change management system component allows for the implementation of clinical quality assurance and control through the ability to revise, version, and track modifications and approvals on controlled documents comprising one or more of protocols, informed consents, case reports forms, investigative brochures, patient materials, and advertising and marketing materials;
a subject registration manager component, wherein the subject registration manager component registers patients and profiles them against clinical trial inclusion and exclusion criteria for appropriate patient recruitment, allows for the collection of demographic, payer, referring physician, and emergency information as one portion of the complete clinical trial-related electronic medical record, and captures information about the referring physician for the purposes of evaluating investigative site performance, gathering patient population characteristics, and maintaining a two-way flow of information pertaining to the patients medical condition and progress through the trial;
a financial account manager component, wherein the financial account manager component enables gate-keeping of medical billing to assure appropriate billing practices in the context of clinical research;
an investigation agent manager component, wherein the investigational agent manager component allows the capture of all drug distribution, tracking, disposition, accountability, transfer, and return in accordance with regulations and a clinical trial protocol;
a patient evaluation manager component, wherein the patient evaluation manager component facilitates interpretive summaries, diagnosis code assignment, and treatment code assignment to allow for assurance of compliance with the clinical trial protocol, proper study visit documentation, streamlined serious adverse event reporting, and clinical outcome evaluation;
a treatment regimen manager component, wherein the treatment regimen manager component allows for a standardized mechanism for treatment courses and dose escalations in accordance with algorithms that are configured in accordance with the clinical trial protocol;
a clinical data import manager component, wherein the clinical data import manager component allows interface with radiology imaging systems for import of radiographic data and diagnostic interpretations, medical information systems for import of medical data, and medical information systems for import of laboratory data for the clinical trial;
an auto encoding component, wherein the auto encoding component codes disease categories and toxicity data through access to current global libraries and coding algorithms; and
an adverse event manager component, wherein the adverse event manager component collects and tracks all adverse events in the clinical trial process.

12. The system of claim 11, wherein the trial conduct application further comprises an encounter scheduler and tracker component, wherein the encounter scheduler and tracker component integrates the scheduling of clinical trial-related visits with routine physician office visits and captures physician-patient encounter data from each clinical trial-related visit.

13. The system of claim 5, wherein the trial monitoring application comprises one or more of
a database snapshot generator component, wherein the database snapshot generator component enables access to data for real-time clinical trial status monitoring at definable intervals for resource allocation, trend analysis, decision support, and interim analysis; and
a subject status manager component, wherein the subject status manager component ascertains the status of all subjects in the clinical trial and captures reasons subjects leave the clinical trial.

14. The system of claim 12, wherein the trial monitoring application further comprises a monitor and auditor manager component, wherein the monitor and auditor manager component assures compliance with regulations requiring specific monitoring and auditing of the clinical trial process.

15. The system of claim 12, wherein the trial monitoring application further comprises a case report form manager component, wherein the case report form manager component allows the design and tracking of paper and electronic case report forms.

16. The system of claim 5, wherein the trial analysis application comprises a clinical outcome manager component, wherein the clinical outcome manager component generates interim and final clinical trial status reports.

17. The system of claim 15, wherein the trial analysis application further comprises an executive information manager component, wherein the executive information manager component allows for the monitoring of key executive vital signs, data analysis, and business intelligence.

18. The system of claim 5, wherein the applications interface application comprises:
an application programming interface component, wherein the application programming interface component enables external applications to communicate with the system; and
an XML Data Pump component, wherein the XML Data Pump component allows import and export of data in XML format to and from the patient records database.

19. The system of claim 18, wherein the applications interface application further comprises a mobile connectivity component, wherein the mobile connectivity component allows mobile devices to enter and retrieve data as the client.

20. The system of claim 18, wherein the applications interface application further comprises a patient records manager component, wherein the patient records manager component allows external electronic medical records to be added to the clinical trials process, which provides the system with demographic information.

21. A method for reporting clinical trials information comprising:
creating reporting requirements for a stakeholder;
extracting data from the system based on the reporting requirements;
validating the data against regulations and standards;
creating information from the data based on what is known about the stakeholder; and
displaying the information to the stakeholder.

22. The method of claim 21, wherein the stakeholder comprises one of sponsor, regulator, investigator, site, patient, and monitor.

23. A method for monitoring events within a system for managing clinical trials, the method comprising:
performing an event in a clinical trials protocol;
checking the event against business logic rules, industry regulations, and industry standards; and
alerting at least one stakeholder of the event.

24. A method for scheduling and tracking appointments of a clinical trial subject comprising:
designing a schedule of subject visits based on a clinical trial protocol;
enrolling a subject based on inclusion and exclusion criteria of the clinical trial protocol;
scheduling subsequent visits for the subject;
providing alerts that the enrolled subject should be sent reminders in advance of subsequent visits of the subject;
generating a checklist upon a visit by the subject;
documenting the checklist of items completed and not completed after the visit by the subject;
documenting cancelled and missed visits by the subject;
dropping the subject if a number of visits cancelled and missed exceeds a threshold;
notifying the subject when the number of visits cancelled and missed exceeds the threshold; and
documenting the dropping of the subject when the number of visits cancelled and missed exceeds the threshold.

25. The method of claim 24, wherein the subsequent visits comprise one or more of an office visit, laboratory tests, x-ray tests, procedures, and preparation for procedures.

26. The method of claim 24, wherein the checklist comprises one or more of prompting a principal investigator review and signature, generating patient instructions, generating a coordinator checklist, checking laboratory results, checking pathology results, checking microbiology results, and checking study reports.

27. The method of claim 24, wherein the threshold of visits cancelled and missed comprises three visits.

28. The method of claim 24, wherein the notifying the subject comprises sending a certified letter to the subject.

29. A method for assuring good clinical information in scheduling and tracking the appointments of a clinical trial subject comprising:
checking a designed schedule of subject visits for consistency with a clinical trial protocol and rules of informed consent;
collecting subject information in a manner compliant with industry regulations and standards;
checking the collected subject information against inclusion and exclusion criteria of business logic rules;
changing subject information coding to indicate enrolled and non-enrolled subjects;
checking lead time of a scheduled visit against all other scheduled visits for conflicts;
assuring that reminder calls are made and documented;
assuring that due diligence is shown and documented in regard to cancelled and missed visits by subjects;
assuring that proper methods are used to drop a subject from the clinical trial;
assuring the proper notice is given to a dropped subject; and
assuring the subject information of a dropped subject is properly identified in the system.

30. A method for alerting and reporting in scheduling and tracking the appointments of a clinical trial subject comprising:
generating subject instructions at time of scheduling a subject visit;
generating a checklist automatically at beginning of the subject visit;
notifying at least one stakeholder at the beginning of the subject visit;
alerting at least one stakeholder if a scheduled visit is missed or cancelled;
alerting at least one stakeholder before a scheduled subject visit;
generating a checklist to track proper compliance with follow-up procedures; and
alerting at least one stakeholder if the subject is dropped for exceeding a threshold of missed and cancelled visits.

31. The method of claim 29, wherein the stakeholder comprises one of sponsor, regulator, investigator, site, patient, and monitor.

32. A method for producing good clinical information within a system for managing clinical trials, the method comprising:
assuring that clinical information is collected in compliance with regulatory requirements;
assuring that the clinical information is collected in accordance with a proper organization workflow;
assuring that the clinical information is collected according to a clinical trial critical path;
assuring data integrity of the clinical information;
assuring the security of the clinical information; and
assuring the privacy of the clinical information.

33. The method of claim 32, wherein the assuring the information is collected in compliance with regulatory requirements comprises assuring consistency with regulations from one or more of the International Conference on Harmonization Good Clinical Practice, the Code of Federal Regulations, the Office of Human Research Protections, and the National Institutes of Health.

34. The method of claim 32, wherein assuring that the clinical information in accordance with a proper organization workflow comprises one or more of integrating business rules, integrating clinical trials processes' connectivity, assuring proper sequencing of critical path elements, assuring proper change management, assuring proper logistics, and collecting the information in accordance with the approved study protocol.

35. The method of claim 32, wherein the assuring data integrity of the clinical information comprises one or more of validating that the information is accurate, determining that the information is relevant to the study being conducted, assuring that the information is in a standardized coding system, assuring that the information is normalized, verifying that the information is complete, assuring that the information is uncorrupted, and assuring that the information is unaltered.

36. The method of claim 32, wherein the assuring the security of the clinical information comprises preventing access to the information by unauthorized non-stakeholders.

37. The method of claim 32, wherein the assuring the privacy of the clinical information comprises preventing access to the information by unauthorized stakeholders.

38. A method for closing-out a clinical trial comprising:
providing a first report of treatment allocation for all enrolled subjects;
providing a second report on all used and unused investigational products;
locking a clinical trial database after completion of all case report forms;
performing a final analysis on the locked clinical trial database;
notifying at least one stakeholder of completion of the clinical trial; and
drafting a final clinical study report.

39. A method for presenting information to stakeholders within a system for managing clinical trials, the method comprising:
creating a digital dashboard for a stakeholder;
displaying a category of information common to all stakeholders on the digital dashboard; and
displaying a category of information specific to the stakeholder on the digital dashboard.

40. The method of claim 39, wherein the stakeholder comprises one of sponsor, regulator, investigator, site, patient, and monitor.

41. The method of claim 39, wherein the category of information common to all stakeholders comprises one or more of an email application, links to Web sites, references to trial information, announcements, and alerts.

42. The method of claim 39, wherein the category of information specific to a sponsor stakeholder comprises one or more of study documents, site performance, action items, financial metrics, good will metrics, safety records, and sponsor performance metrics.

43. The method of claim 39, wherein the category of information specific to a regulator stakeholder comprises one or more of study documents, site performance, action items, and site adverse events.

44. The method of claim 39, wherein the category of information specific to an investigator stakeholder comprises one or more of monitoring schedule, action items, monthly and daily schedule, site performance metrics, queries, milestones, and site adverse events.

45. The method of claim 39, wherein the category of information specific to a site stakeholder comprises one or more of monitoring schedule, action items, site statistics, site performance metrics, waiting response, safety training, pending investigational new drug reports, special handling information, efficacy summary, and safety summary.

46. The method of claim 39, wherein the category of information specific to a patient stakeholder comprises one or more of investigator profile, information about the study disease, patient record, reminders, instructions, and study documents.

47. The method of claim 39, wherein the category of information specific to a monitor stakeholder comprises one or more of multi-site monitoring, milestones, adverse events, action items, queries, and multi-site performance metrics.
